(19) United States
(12) Patent Application Publication
(10) Pub. No.: US 2026/0236177 A1
(43) Pub. Date: Aug. 13, 2026

(54) BACKGROUND CHANGE LOG LOADING FOR POWER LOSS WITHIN A MEMORY SYSTEM

(71) Applicant: Micron Technology, Inc., Boise, ID (US)

(72) Inventors: Liu Zhao, Shanghai (CN); Xiao Wang, Shanghai (CN); Xing Wang, Shanghai (CN); Qingyuan Wang, Shanghai (CN)

(21) Appl. No.: 19/468,889

(22) Filed: Feb. 3, 2026

Related U.S. Application Data
(60) Provisional application No. 63/755,882, filed on Feb. 7, 2025.

(51) Int. Cl. G06F 3/06

(52) U.S. Cl. CPC G06F 3/0619; G06F 3/0659; G06F 3/0683

(57) ABSTRACT

Methods, systems, and devices for background change log loading for power loss within a memory system are described. Techniques described herein may enable a memory system to insert a flag having a value that indicates whether a logical block address has been inserted into a foreground change log as part of a garbage collection operation. In response to performing a merge operation to flush a logical-to-physical (L2P) mapping from a volatile memory to a non-volatile memory, the memory system may determine, in accordance with the value of the flag, whether to store one or more entries of the background change log to the non-volatile memory, or whether to invalidate the one or more entries in the L2P mapping. If the memory system loses power unexpectedly, the memory system may rebuild the background change log upon power on using the pointers.

### CROSS REFERENCE

The present Application for Patent claims priority to U.S. Patent Application No. 63/755,882 by Zhao et al., entitled “BACKGROUND CHANGE LOG LOADING FOR POWER LOSS WITHIN A MEMORY SYSTEM,” filed Feb. 07, 2025, which is assigned to the assignee hereof, and which is expressly incorporated by reference in its entirety herein.

### TECHNICAL FIELD

The following relates to one or more systems for memory, including background change log loading for power loss within a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports background change log loading for power loss within a memory system in accordance with examples as disclosed herein.

FIG. 2 shows an example of a flowchart that supports background change log loading for power loss within a memory system in accordance with examples as disclosed herein.

FIG. 3 shows an example of a flowchart that supports background change log loading for power loss within a memory system in accordance with examples as disclosed herein.

FIG. 4 shows a block diagram of a memory system that supports background change log loading for power loss within a memory system in accordance with examples as disclosed herein.

FIG. 5 shows a flowchart illustrating a method or methods that support background change log loading for power loss within a memory system in accordance with examples as disclosed herein.

### DETAILED DESCRIPTION

Some memory systems may implement changelogs associated with storing mappings of logical block addresses (LBAs) and physical addresses of the memory system (e.g., of a non-volatile memory of the memory system). For example, the change logs may include or otherwise represent examples of entries for a logical-to-physical (L2P) mapping table, in some examples. To support relatively high throughout, a memory system may maintain a foreground change log associated with storing new mappings received from a host system and a background change log associated with storing old mappings received from the foreground change log. The memory system may be configured to transfer old mappings from the background change log to information, such as a mapping table, of the memory system before transferring new mappings received from the host system from the foreground change log to the background change log. The mapping table may be updated each time the background change log is emptied. In some examples, as part of a garbage collection operation, a controller of the memory system may insert dummy data (e.g., invalid LBAs, some default value, or the like) into the foreground change log if the host system has overwritten an LBA in the background change log to protect the data written by the host from being garbage collected. In some examples, if the memory system loses power after flushing the background change log, but before flushing the dummy entry from the foreground change log to a non-volatile memory, the memory system may not be able to rebuild garbage collection information that indicates which addresses are targeted for garbage collection without reading from the non-volatile memory. In such cases, the memory system may load validity information from the non-volatile memory to determine if one or more associated physical addresses are valid, which may increase a latency associated with rebuilding mapping information and garbage collection information following the power loss event.

Accordingly, techniques described herein may enable the memory system to rebuild mapping information for garbage collection in volatile memory and with reduced latency. As described herein, the memory system may insert a flag that indicates whether an LBA has been inserted into the foreground change log as part of a garbage collection operation. For example, if the memory system inserts a dummy entry into the foreground change log during a garbage collection operation, the memory system may set the flag to a first value, and the flag may be set to a second (e.g., default value) if no entry is inserted into the foreground change log. Each time the memory system flushes the mapping information from volatile memory to a non-volatile memory (e.g., a physical page table (PPT) merge operation), the memory system may determine, according to the value of the flag, whether to also flush one or more entries of the background change log to the non-volatile memory and to store a pointer to the one or more entries in the mapping information, or to invalidate the one or more entries in the mapping information. After power is regained at the memory system, the memory system may determine whether the address is valid, and may rebuild the background change log using the pointers in the mapping information, or may refrain from rebuilding the background change log according to whether the entries are validated, such that the background change log and corresponding garbage collection information may be rebuilt relatively efficiently.

In addition to applicability in memory systems as described herein, techniques for loading background change logs for power loss events may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving restoration speeds following a power loss event, which may decrease processing or latency times, improve response times, or otherwise improve user experience, among other benefits.

In addition to applicability in memory systems described herein, techniques for loading background change logs for power loss events may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by ensuring validity of stored LBAs, and may incur lower latency costs relative to other solutions, among other benefits.

Features of the disclosure are illustrated and described in the context of systems, devices, and circuits. Features of the disclosure are further illustrated and described in the context of block diagrams and flowcharts.

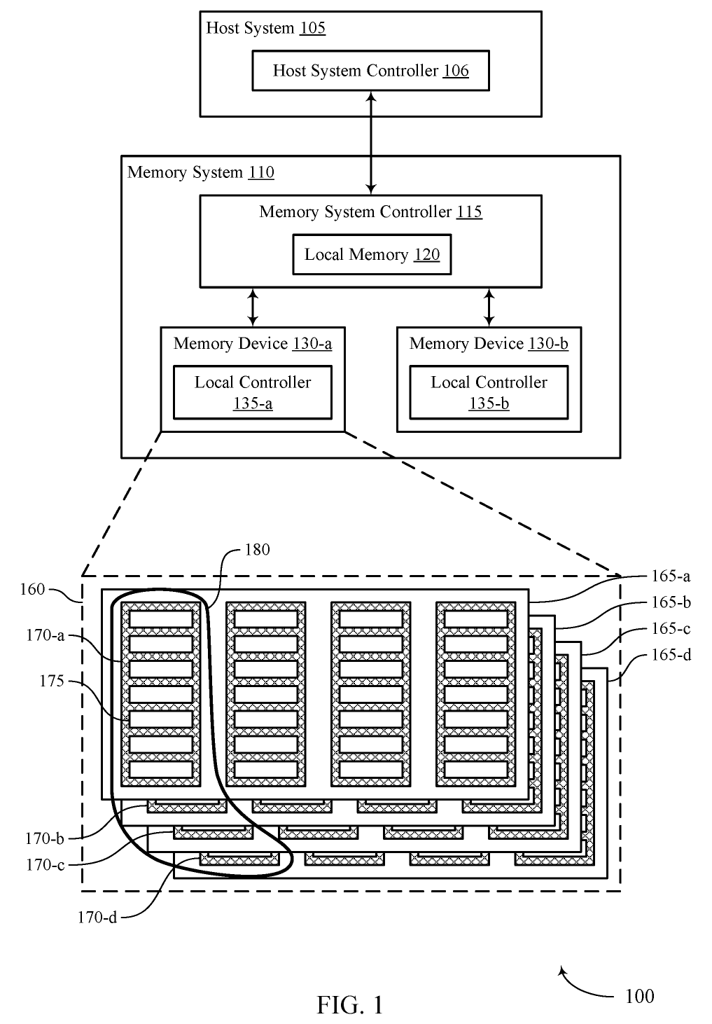

FIG. 1 shows an example of a system 100 that supports background change log loading for power loss within a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded

Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a,170-b, 170-c, and 170-d that are within planes 165-a, 165-b,165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105). The memory system controller 115 or local controller 135 may maintain a table (e.g., a garbage collection table) that indicates the locations of the valid data and the invalid data. The garbage collection table may be an example of an L2P table.

In some examples, the memory system 110 may include a volatile memory and a non-volatile memory. The volatile memory and the non-volatile memory may each be coupled with the memory system controller 115, such that the memory system controller 115 may facilitate operations of the volatile memory and the non-volatile memory. In some cases, the volatile memory may be an SRAM array, a cache, or a local memory, among other examples. For example, the volatile memory may be a local memory 120 of the memory system controller 115. In some cases, the non-volatile memory may be an example of a memory device 130. For example, the non-volatile memory may be a NAND memory array of the memory device 130, and the non-volatile memory may include a quantity of NAND memory cells.

The volatile memory may include one or more change logs (e.g., a first change log and a second change log). The change logs may each be configured to store updated mappings between logical addresses of the non-volatile memory and physical addresses of the non-volatile memory. For example, the change logs may include entries each corresponding to a mapping between a logical address and a physical address of the non-volatile memory. In some cases, the logical addresses may be LBAs and the physical addresses may be physical page addresses. The first change log may be an example of a foreground change log, such that the first change log may be configured to store new entries received from the host system 105. For example, a host write command may indicate a mapping between a logical address and a physical address, and an entry associated with the mapping may be stored in the first change log for at least a time period. The second change log may be an example of a background change log, such that the second change log may be configured to store the entries transferred from the first change log. For example, the memory system controller 115 may transfer the entries (e.g., older entries) from the first change log to the second change log to support storing new entries received from the host system 105 at the first change log. In some examples, the memory system controller 115 may transfer the entries from the first change log to the second change log in accordance with a capacity of the first change log being satisfied.

The volatile memory and the non-volatile memory may each include a mapping table, which may be an example of an L2P mapping table. For example, the volatile memory may be configured to store a first mapping table and the non-volatile memory may be configured to store a second mapping table. In some such examples, the first mapping table (e.g., a physical page table (PPT)) may be a portion of the second mapping table (e.g., an L2P table). That is, the first mapping table may be stored in the volatile memory because the volatile memory may support relatively faster (e.g., lower latency) access operations than the non-volatile memory. Each mapping table may include physical addresses of the non-volatile memory. For example, each mapping table may be sorted (e.g., numerically sorted) in accordance with logical addresses associated with the physical addresses of the non-volatile memory, such that the mapping tables may not include logical addresses (e.g., the logical addresses are assumed in accordance with the sorting of the mapping tables). Instead, each mapping table may be associated with an initial logical address (e.g., a region number), such that a logical address associated with a physical address may be identified according to the mapping tables being implicitly sorted according to the logical addresses. Further, each mapping table may include the entries for each physical address.

In some cases, the first mapping table may be updated with the entries from the second change log. For example, the memory system controller 115 may transfer the entries (e.g., older entries) from the second change log to the first mapping table to support storing new entries received from the first change log at the second change log. In some examples, the memory system controller 115 may transfer the entries from the second change log to the first mapping table in response to a threshold associated with the first change log being satisfied. In some cases, transferring the entries from the second change log to the first mapping table may include updating and/or merging the entries stored in the first mapping table with the entries received from the second change log. In some examples, the first mapping table may be updated each time the entries are transferred from the first change log to the second change log.

In some cases, the second mapping table may be updated with the entries from the first mapping table. For example, the memory system controller 115 may transfer the entries from the first mapping table to the second mapping table to support storing new entries received from the second changelog at the first mapping table. In some examples, the memory system controller 115 may transfer the entries from the first mapping table to the second mapping table in response to a capacity associated with the first mapping table being satisfied. In some examples, the memory system controller 115 may transfer the entries from the first mapping table to the second mapping table other times the entries are transferred from the second change log to the first mapping table. In some cases, transferring the entries from the first mapping table to the second mapping table may include updating and/or merging the entries stored in the second mapping table with the entries received from the first mapping table. In some examples, transferring the entries from the first mapping table to the second mapping table may include flushing the first mapping table, such that the first mapping table may be emptied as a result of transferring the entries. In some examples, transferring the entries from the first mapping table in the volatile memory to the second mapping table in the non-volatile memory may be referred to as a merge operation (e.g., a PPT merge operation).

In accordance with some aspects described herein, the system 100 may support techniques for the memory system 110 to insert a flag that indicates whether an LBA has been inserted into the foreground change log as part of a garbage collection operation. The memory system 110 may perform a merge operation to store the L2P mapping to a non-volatile memory (e.g., from the first mapping table to the second mapping table), and the memory system 110 may determine whether to store one or more entries of the background change log to the non-volatile memory and to store a pointer to the one or more entries in the L2P mapping, or to invalidate the one or more entries in the L2P mapping in accordance with the value of the flag. Following a power loss event, the memory system 110 may determine whether the address is valid, and may rebuild the background change log using the pointers or may refrain from rebuilding the background change log according to whether the entries are validated.

The system 100 may include any quantity of non-transitory computer readable media that support background change log loading for power loss within a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

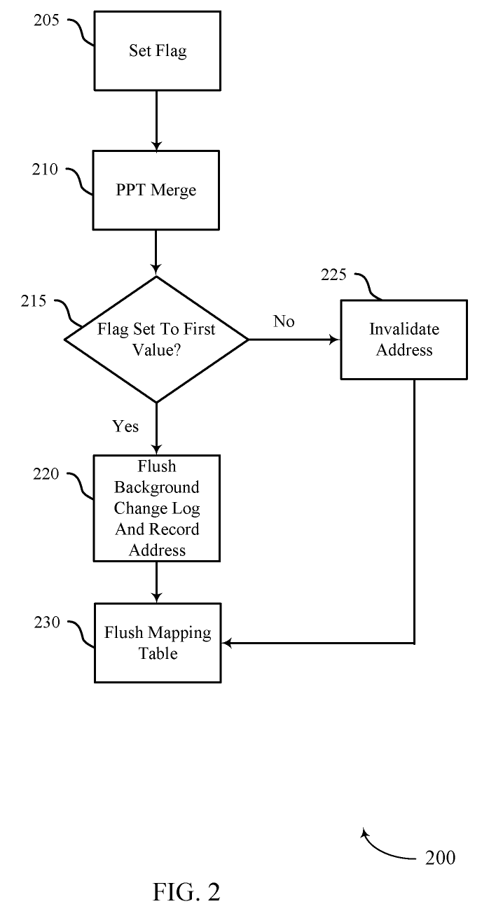

FIG. 2 shows an example of a flowchart 200 that supports background change log loading for power loss within a memory system in accordance with examples as disclosed herein. The flowchart 200 may implement aspects or operations of a system, which may be an example of a system 100, as described with reference to FIG. 1. For example, the flowchart 200 may be implemented by a memory system 110, which may be an example of a memory system 110 as described with reference to FIG. 1.

Aspects of the flowchart 200 may be implemented by one or more controllers, among other components. Additionally, or alternatively, aspects of the flowchart 200 may be implemented as instructions stored in one or more memories (e.g., firmware stored in one or more memories coupled with a memory system). For example, the instructions, when executed by one or more controllers (e.g., a memory system controller or a local controller), may cause the one or more controllers (or a device or a system) to perform the operations of the flowchart 200.

Although shown in a particular sequence or order, unless otherwise specified, the order of the processes may be modified. Thus, the illustrated examples are used as examples, and the illustrated processes may be performed in a different order, and some processes may be performed in parallel. Additionally, one or more processes may be omitted in various examples. Thus, not all processes are used in every example. Other flows are possible.

In some examples, as described with reference to FIG. 1, a memory controller (e.g., a memory system controller or a local controller of a memory system) may perform a garbage collection procedure to relocate valid data and erase blocks of invalid data, which may increase a quantity of free blocks that are available to store new data. In some examples, the garbage collection procedure may share one or more change logs with a host system. For example, if the memory controller determines that an LBA of a garbage collection address table has been inserted into a background change log by an overwrite by the host system, the garbage collection procedure may include inserting dummy data (e.g., a dummy or invalid address) to a foreground change log via a conditional insert procedure by a change log management. Such techniques may ensure that newest data stored in the change logs includes data overwritten by the host system.

The memory controller may perform a background change log merge procedure (e.g., a PPT merge) to transfer one or more entries of an L2P mapping table from a volatile memory of the memory system to a non-volatile memory of the memory system. Accordingly, the L2P mapping table in the non-volatile memory may be up-to-date. In some examples, however, the memory controller (e.g., firmware (FW) of the memory system) may not merge the dummy addresses stored in the foreground change log before a power loss event (e.g., an asynchronous power loss (APL)). In such cases, to rebuild the L2P mapping table in the volatile memory, the memory controller may read data from the non-volatile memory (e.g., NAND data), which may be relatively inefficient and may increase latency.

For example, as part of a boot-up stage (e.g., a boot flow), the memory controller may rebuild a garbage collection address table by loading a page validity table (PVT) bitmap indicating which pages of a source block include valid or invalid data. The memory controller may determine if the PVT bitmap indicates that an address is invalid, and may accordingly insert a dummy L2P mapping to the garbage collection address table. Additionally, or alternatively, the memory controller may generate the PVT using a block valid region table (BVRT), which may increase latency associated with the boot-up stage.

Accordingly, techniques described herein may enable the memory controller to rebuild the garbage collection address table more efficiently (e.g., without loading the PVT or BVRT from non-volatile memory), which may decrease latency associated with the boot-up stage. The described techniques may support a flag that indicates whether a dummy LBA is inserted into the foreground change log or not, which may facilitate more efficient loading of data to support relatively quick reboot processes.

For example, at 205, a flag (e.g., a GcInsertedFLFlag) of a PPT log buffer may be set to a first value indicating that an LBA of the memory system is inserted into the foreground change log as part of the garbage collection procedure, or to a second value indicating that the LBA is not inserted into the foreground change log as part of the garbage collection procedure. In some examples, the second value may be a default value and the memory controller may not actively change the value of the flag if no LBA is inserted.

That is, during a garbage collection scan operation, the memory controller may identify one or more target LBAs for garbage collection. The memory controller may write the first LBA to the foreground change log and set the flag to the first value in response to writing the LBA to the foreground change log. In some examples, if the memory controller identifies that the one or more target LBAs are already written to the background change log (e.g., by host overwrite, for example), the memory controller may write a dummy value to the foreground change log. The dummy value may be a pointer to the one or more target LBAs in the background change log, in some examples. Additionally, or alternatively, the memory controller may not write the first LBA to the foreground change log if, for example, the memory controller determines to refrain from garbage collecting the first LBA, for example. In such examples, the memory controller may set the flag to the second value in response to refraining from writing the first LBA to the foreground change log.

At 210, a merge operation (e.g., PPT merge) to transfer one or more entries of the background change log to the L2P mapping table before transferring the L2P mapping table from the volatile memory of the memory system to the non-volatile memory of the memory system may be performed. For example, the memory controller may perform the merge operation periodically, in accordance with a capacity of the L2P mapping table, in accordance with a capacity of the foreground change log, in accordance with a capacity of the background change log, or any combination thereof. At 215, the value of the flag may be determined in response to performing the PPT merge. For example, the memory controller may poll or otherwise monitor (e.g., read, check, scan) the flag to determine whether the flag is set to the first value or the second value. The memory controller may determine, in accordance with the value of the flag, whether to transfer one or more entries of the background change log to the non-volatile memory (e.g., to flush the background change log) or to invalidate the one or more entries of the background change log. The one or more entries of the background change log may include an L2P mapping (e.g., a mapping between a physical address of the non-volatile memory and a logical address of the non-volatile memory).

At 220, if the flag is set to the first value (e.g., a value of one, or a high value), the background change log may be flushed (e.g., to transfer at least a first entry of the background change log to the non-volatile memory). For example, the memory controller may flush the background change log during a task to flush a page of an L2P mapping table of the memory system. The memory controller may record the address of at least the first entry (e.g., or any other entries that are flushed, if non-sequential with the first entry) by storing a pointer to a first physical address associated with the first entry to the L2P mapping table (e.g., a first level of a PPT mapping table, or some other example). Thus, if any dummy LBA in the foreground change log points to an entry in the background change log, the storage of the pointer to the physical address of the corresponding entry in the background change log may improve efficiency associated with rebuilding the change logs and target garbage collection information after a power loss event.

Additionally, or alternatively, at 225, if the flag is set to the second value (e.g., zero, a low value, a default value), the background change log may not be flushed (e.g., may not transfer the one or more entries of the background change log to the non-volatile memory). For example, the memory controller may determine not to flush the background change log. The memory controller may invalidate at least a second address of the L2P mapping table associated with the background change log. For example, if the flag is set to the second value, the flag may indicate that the LBA associated with the entry has been overwritten by the host system.

At 230, the mapping table may be flushed (e.g., saved to the non-volatile memory). For example, the memory system may store the first level of the PPT mapping table to the non-volatile memory (e.g., to the L2P mapping of the non-volatile memory).

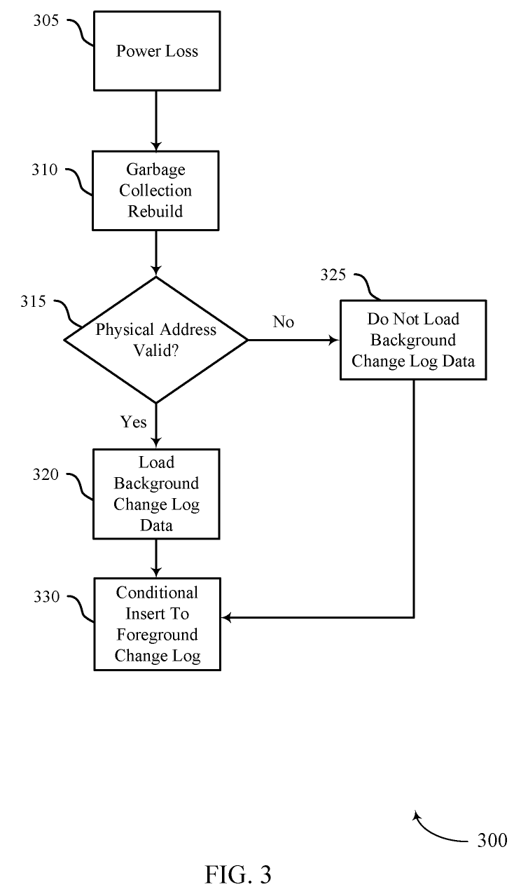

FIG. 3 shows an example of a flowchart 300 that supports background change log loading for power loss within a memory system in accordance with examples as disclosed herein. The flowchart 300 may implement aspects or operations of a system, which may be an example of a system 100, as described with reference to FIG. 1. For example, the flowchart 200 may be implemented by a memory system 110, which may be an example of a memory system 110 as described with reference to FIG. 1.

Aspects of the flowchart 300 may be implemented by one or more controllers, among other components. Additionally, or alternatively, aspects of the flowchart 300 may be implemented as instructions stored in one or more memories (e.g., firmware stored in one or more memories coupled with a memory system). For example, the instructions, when executed by one or more controllers (e.g., a memory system controller or a local controller), may cause the one or more controllers (or a device or a system) to perform the operations of the flowchart 300.

Although shown in a particular sequence or order, unless otherwise specified, the order of the processes may be modified. Thus, the illustrated examples are used as examples, and the illustrated processes may be performed in a different order, and some processes may be performed in parallel. Additionally, one or more processes may be omitted in various examples. Thus, not all processes are used in every example. Other flows are possible.

At 305, a power loss event may occur. For example, a memory controller (e.g., a memory system controller or a local controller of a memory system) may experience APL. The power may be lost for some duration before power is re-supplied to the memory system. After the power is returned, the memory controller may determine to rebuild a garbage collection address table (e.g., a list of target addresses for garbage collection) within a volatile memory of the memory system.

At 310, a garbage collection address table rebuilding operation may be performed in response to the power loss event and regaining of the power. For example, the memory controller may perform a second garbage collection scan operation to identify one or more target LBAs for garbage collection.

At 315, it may be determined whether a physical address indicated by an L2P mapping table (e.g., stored in a non-volatile memory of the memory system) is valid. For example, the memory controller may determine whether the physical address is valid or invalid. The physical address may be an address that is pointed to by the entry in the L2P mapping table (e.g., DM_SystemInfoPtr->BgCLMPhyAddr). At 320, one or more background change log entries stored according to an address of a page in a mapping table (e.g., indicated by a pointer in the non-volatile memory, as described with reference to FIG. 2) may be loaded to volatile memory if the entries are valid. That is, the memory controller may retrieve the pointer to a first physical address and may copy a first entry from the non-volatile memory indicated by the pointer to the background change log.

At 325, if the entries of the background change log are not valid, the entries may not be loaded. That is, the memory controller may retrieve an address from the L2P mapping table in the non-volatile memory and may refrain from copying the second address to the background change log if the second address is invalid. Such conditional loading may reduce latency and overhead as compared with rebuild techniques in which the memory controller loads all of the mapping information from the non-volatile memory.

At 330, a conditional insert procedure may be applied to a foreground change log of the memory system. For example, as part of the garbage collection scan operation, the memory controller may store the one or more target LBAs to the garbage collection address table (e.g., in accordance with storing the pointer or invalidating the address). The memory controller may perform a conditional insert to insert one or more LBAs from the garbage collection address table to the foreground change log, or to insert dummy LBAs to the foreground change log (e.g., if an LBA is already loaded in the background change log). The memory system may accordingly keep most up-to-date data (e.g., data overwritten by a host system) without loading a PVT or BVRT for each source block, as described with reference to FIG. 2. Such techniques may reduce a latency and overhead associated with boot-up procedures following APL, among other examples.

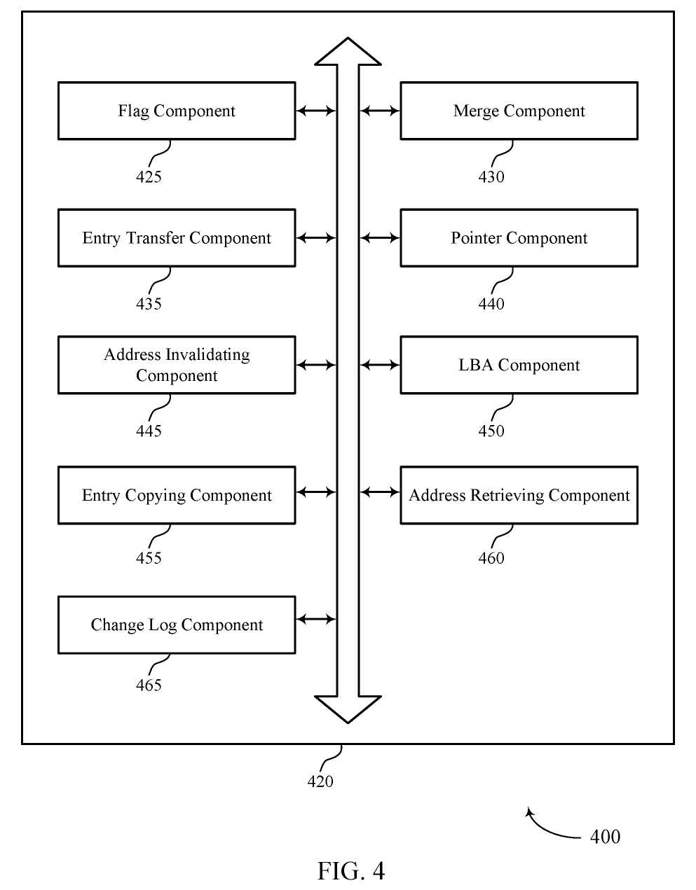

FIG. 4 shows a block diagram 400 of a memory system 420 that supports background change log loading for power loss within a memory system in accordance with examples as disclosed herein. The memory system 420 may be an example of aspects of a memory system as described with reference to FIGS. 1 through 3. The memory system 420, or various components thereof, may be an example of means for performing various aspects of background change log loading for power loss within a memory system as described herein. For example, the memory system 420 may include a flag component 425, a merge component 430, an entry transfer component 435, a pointer component 440, an address invalidating component 445, an LBA component 450, an entry copying component 455, an address retrieving component 460, a change log component 465, or any combination thereof. Each of these components, or components of subcomponents thereof (e.g., one or more processors, one or more memories), may communicate, directly or indirectly, with one another (e.g., via one or more buses).

The flag component 425 may be configured as or otherwise support a means for setting a value of a flag to indicate whether a first LBA within the memory system is inserted into a first change log in a volatile memory of the memory system as part of a garbage collection scan operation. The merge component 430 may be configured as or otherwise support a means for performing, after setting the value of the flag, a merge operation associated with transferring a first plurality of entries of a L2P mapping stored at the volatile memory of the memory system to a non-volatile memory of the memory system. The entry transfer component 435 may be configured as or otherwise support a means for determining, after performing the merge operation and in accordance with the value of the flag, whether to transfer a second plurality of entries of a second change log from the volatile memory to the non-volatile memory, one or more entries of the second plurality of entries in the second change log including a mapping between a logical address of the non-volatile memory of the memory system and a physical address of the non-volatile memory.

In some examples, to support determining whether to transfer the second plurality of entries of the second change log from the volatile memory to the non-volatile memory, the entry transfer component 435 may be configured as or otherwise support a means for determining, in accordance with the value of the flag being a first value, to transfer the second plurality of entries of the second change log from the volatile memory to the non-volatile memory, where the first value of the flag indicates that the first LBA is inserted into the first change log. In some examples, to support determining whether to transfer the second plurality of entries of the second change log from the volatile memory to the non-volatile memory, the entry transfer component 435 may be configured as or otherwise support a means for transferring, to the non-volatile memory in accordance with the determining, at least a first entry of the second plurality of entries in the second change log. In some examples, to support determining whether to transfer the second plurality of entries of the second change log from the volatile memory to the non-volatile memory, the pointer component 440 may be configured as or otherwise support a means for storing, to the L2P mapping stored in the non-volatile memory, a pointer to a first physical address associated with the first entry.

In some examples, the pointer component 440 may be configured as or otherwise support a means for retrieving, in response to powering on after a power loss event of the memory system, the pointer to the first physical address. In some examples, the entry copying component 455 may be configured as or otherwise support a means for copying, in accordance with the first physical address, the first entry from the non-volatile memory to the second change log in the volatile memory.

In some examples, the LBA component 450 may be configured as or otherwise support a means for performing, after a power loss event of the memory system, a second garbage collection scan operation to identify one or more target LBAs for garbage collection. In some examples, the LBA component 450 may be configured as or otherwise support a means for storing the one or more target LBAs to a garbage collection address table in accordance with the second garbage collection scan operation and in accordance with transferring at least the first entry of the second change log to the non-volatile memory before the power loss event.

In some examples, to support determining whether to transfer the second plurality of entries of the second change log from the volatile memory to the non-volatile memory, the flag component 425 may be configured as or otherwise support a means for determining, in accordance with the value of the flag being a second value, to refrain from transferring the second plurality of entries of the second change log from the volatile memory to the non-volatile memory, where the second value of the flag indicates that the first LBA is not inserted into the first change log. In some examples, to support determining whether to transfer the second plurality of entries of the second change log from the volatile memory to the non-volatile memory, the address invalidating component 445 may be configured as or otherwise support a means for invalidating, in accordance with the determining, a second physical address within the L2P mapping, where the second physical address is associated with the second change log.

In some examples, the address retrieving component 460 may be configured as or otherwise support a means for retrieving, in response to powering on after a power loss event of the memory system, the second physical address from the L2P mapping in the non-volatile memory. In some examples, the change log component 465 may be configured as or otherwise support a means for refraining from rebuilding the second change log in accordance with the second physical address being invalid.

In some examples, the LBA component 450 may be configured as or otherwise support a means for performing, in response to powering on after a power loss event of the memory system, a second garbage collection scan operation to identify one or more target LBAs for garbage collection. In some examples, the LBA component 450 may be configured as or otherwise support a means for storing the one or more target LBAs to a garbage collection address table in accordance with the second garbage collection scan operation.

In some examples, the LBA component 450 may be configured as or otherwise support a means for performing the garbage collection scan operation to identify a plurality of target LBAs for garbage collection. In some examples, the LBA component 450 may be configured as or otherwise support a means for writing the first logical block address to the first change log in the volatile memory in accordance with the plurality of target LBAs including the first LBA, where the value of the flag is set to a first value in response to writing the first LBA to the first change log.

In some examples, the LBA component 450 may be configured as or otherwise support a means for performing the garbage collection scan operation to identify a plurality of target LBAs for garbage collection. In some examples, the LBA component 450 may be configured as or otherwise support a means for refraining from writing the first LBA to the first change log in the volatile memory in accordance with the first LBA not being included in the plurality of target LBAs, where the value of the flag is set to a second value in response to refraining from writing the first LBA to the first change log.

In some examples, a first value of the flag indicates that the first LBA is inserted into the first change log. In some examples, a second value of the flag indicates that the first LBA is not inserted into the first change log.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

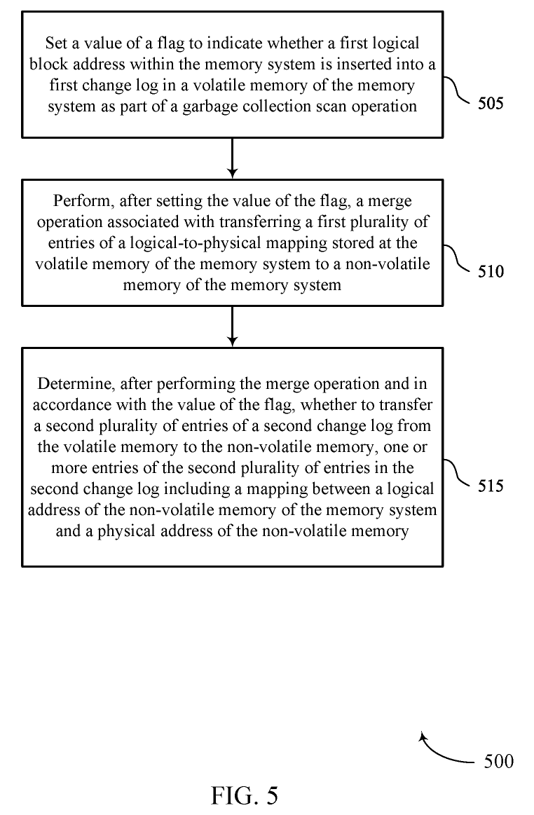

FIG. 5 shows a flowchart illustrating a method 500 that supports background change log loading for power loss within a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include setting a value of a flag to indicate whether a first LBA within the memory system is inserted into a first change log in a volatile memory of the memory system as part of a garbage collection scan operation. In some examples, aspects of the operations of 505 may be performed by a flag component 425 as described with reference to FIG. 4.

At 510, the method may include performing, after setting the value of the flag, a merge operation associated with transferring a first plurality of entries of a L2P mapping stored at the volatile memory of the memory system to a non-volatile memory of the memory system. In some examples, aspects of the operations of 510 may be performed by a merge component 430 as described with reference to FIG. 4.

At 515, the method may include determining, after performing the merge operation and in accordance with the value of the flag, whether to transfer a second plurality of entries of a second change log from the volatile memory to the non-volatile memory, one or more entries of the second plurality of entries in the second change log including a mapping between a logical address of the non-volatile memory of the memory system and a physical address of the non-volatile memory. In some examples, aspects of the operations of 515 may be performed by an entry transfer component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for setting a value of a flag to indicate whether a first LBA within the memory system is inserted into a first change log in a volatile memory of the memory system as part of a garbage collection scan operation; performing, after setting the value of the flag, a merge operation associated with transferring a first plurality of entries of a L2P mapping stored at the volatile memory of the memory system to a non-volatile memory of the memory system; and determining, after performing the merge operation and in accordance with the value of the flag, whether to transfer a second plurality of entries of a second change log from the volatile memory to the non-volatile memory, one or more entries of the second plurality of entries in the second change log including a mapping between a logical address of the non-volatile memory of the memory system and a physical address of the non-volatile memory.

Aspect 2: The method, apparatus, or non-transitory computer-readable medium of aspect 1, where determining whether to transfer the second plurality of entries of the second change log from the volatile memory to the non-volatile memory includes operations, features, circuitry, logic, means, or instructions, or any combination thereof for determining, in accordance with the value of the flag being a first value, to transfer the second plurality of entries of the second change log from the volatile memory to the non-volatile memory, where the first value of the flag indicates that the first LBA is inserted into the first change log, and where the method further includes; transferring, to the non-volatile memory in accordance with the determining, at least a first entry of the second plurality of entries in the second change log; and storing, to the L2P mapping stored in the non-volatile memory, a pointer to a first physical address associated with the first entry.

Aspect 3: The method, apparatus, or non-transitory computer-readable medium of aspect 2, further including operations, features, circuitry, logic, means, or instructions, or any combination thereof for retrieving, in response to powering on after a power loss event of the memory system, the pointer to the first physical address and copying, in accordance with the first physical address, the first entry from the non-volatile memory to the second change log in the volatile memory.

Aspect 4: The method, apparatus, or non-transitory computer-readable medium of any of aspects 2 through 3, further including operations, features, circuitry, logic, means, or instructions, or any combination thereof for performing, after a power loss event of the memory system, a second garbage collection scan operation to identify one or more target LBAs for garbage collection and storing the one or more target LBAs to a garbage collection address table in accordance with the second garbage collection scan operation and in accordance with transferring at least the first entry of the second change log to the non-volatile memory before the power loss event.

Aspect 5: The method, apparatus, or non-transitory computer-readable medium of any of aspects 1 through 4, where determining whether to transfer the second plurality of entries of the second change log from the volatile memory to the non-volatile memory includes operations, features, circuitry, logic, means, or instructions, or any combination thereof for determining, in accordance with the value of the flag being a second value, to refrain from transferring the second plurality of entries of the second change log from the volatile memory to the non-volatile memory, where the second value of the flag indicates that the first LBA is not inserted into the first change log, and where the method further includes invalidating, in accordance with the determining, a second physical address within the L2P mapping, where the second physical address is associated with the second change log.

Aspect 6: The method, apparatus, or non-transitory computer-readable medium of aspect 5, further including operations, features, circuitry, logic, means, or instructions, or any combination thereof for retrieving, in response to powering on after a power loss event of the memory system, the second physical address from the L2P mapping in the non-volatile memory and refraining from rebuilding the second change log in accordance with the second physical address being invalid.

Aspect 7: The method, apparatus, or non-transitory computer-readable medium of any of aspects 5 through 6, further including operations, features, circuitry, logic, means, or instructions, or any combination thereof for performing, in response to powering on after a power loss event of the memory system, a second garbage collection scan operation to identify one or more target LBAs for garbage collection and storing the one or more target LBAs to a garbage collection address table in accordance with the second garbage collection scan operation.

Aspect 8: The method, apparatus, or non-transitory computer-readable medium of any of aspects 1 through 7, further including operations, features, circuitry, logic, means, or instructions, or any combination thereof for performing the garbage collection scan operation to identify a plurality of target LBAs for garbage collection and writing the first LBA to the first change log in the volatile memory in accordance with the plurality of target LBAs including the first LBA, where the value of the flag is set to a first value in response to writing the first LBA to the first change log.

Aspect 9: The method, apparatus, or non-transitory computer-readable medium of any of aspects 1 through 8, further including operations, features, circuitry, logic, means, or instructions, or any combination thereof for performing the garbage collection scan operation to identify a plurality of target LBAs for garbage collection and refraining from writing the first LBA to the first change log in the volatile memory in accordance with the first LBA not being included in the plurality of target LBAs, where the value of the flag is set to a second value in response to refraining from writing the first LBA to the first change log.

Aspect 10: The method, apparatus, or non-transitory computer-readable medium of any of aspects 1 through 9, where a first value of the flag indicates that the first LBA is inserted into the first change log and a second value of the flag indicates that the first LBA is not inserted into the first change log.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
set a value of a flag to indicate whether a first logical block address within the memory system is inserted into a first change log in a volatile memory of the memory system as part of a garbage collection scan operation;
perform, after setting the value of the flag, a merge operation associated with transferring a first plurality of entries of a logical-to-physical mapping stored at the volatile memory of the memory system to a non-volatile memory of the memory system; and
determine, after performing the merge operation and in accordance with the value of the flag, whether to transfer a second plurality of entries of a second change log from the volatile memory to the non-volatile memory, one or more entries of the second plurality of entries in the second change log comprising a mapping between a logical address of the non-volatile memory of the memory system and a physical address of the non-volatile memory.

2. The memory system of claim 1, wherein, to determine whether to transfer the second plurality of entries of the second change log from the volatile memory to the non-volatile memory, the processing circuitry is configured to cause the memory system to:
determine, in accordance with the value of the flag being a first value, to transfer the second plurality of entries of the second change log from the volatile memory to the non-volatile memory, wherein the first value of the flag indicates that the first logical block address is inserted into the first change log, and wherein the processing circuitry is configured to cause the memory system to:
transfer, to the non-volatile memory in accordance with the determining, at least a first entry of the second plurality of entries in the second change log; and
store, to the logical-to-physical mapping stored in the non-volatile memory, a pointer to a first physical address associated with the first entry.

3. The memory system of claim 2, wherein the processing circuitry is configured to cause the memory system to:
retrieve, in response to powering on after a power loss event of the memory system, the pointer to the first physical address; and
copy, in accordance with the first physical address, the first entry from the non-volatile memory to the second change log in the volatile memory.

4. The memory system of claim 2, wherein the processing circuitry is configured to cause the memory system to:
perform, after a power loss event of the memory system, a second garbage collection scan operation to identify one or more target logical block addresses for garbage collection; and
store the one or more target logical block addresses to a garbage collection address table in accordance with the second garbage collection scan operation and in accordance with transferring at least the first entry of the second change log to the non-volatile memory before the power loss event.

5. The memory system of claim 1, wherein, to determine whether to transfer the second plurality of entries of the second change log from the volatile memory to the non-volatile memory, the processing circuitry is configured to cause the memory system to:
determine, in accordance with the value of the flag being a second value, to refrain from transferring the second plurality of entries of the second change log from the volatile memory to the non-volatile memory, wherein the second value of the flag indicates that the first logical block address is not inserted into the first change log, and wherein the processing circuitry is configured to cause the memory system to:
invalidate, in accordance with the determining, a second physical address within the logical-to-physical mapping, wherein the second physical address is associated with the second change log.

6. The memory system of claim 5, wherein the processing circuitry is configured to cause the memory system to:
retrieve, in response to powering on after a power loss event of the memory system, the second physical address from the logical-to-physical mapping in the non-volatile memory; and
refrain from rebuilding the second change log in accordance with the second physical address being invalid.

7. The memory system of claim 5, wherein the processing circuitry is configured to cause the memory system to:
perform, in response to powering on after a power loss event of the memory system, a second garbage collection scan operation to identify one or more target logical block addresses for garbage collection; and
store the one or more target logical block addresses to a garbage collection address table in accordance with the second garbage collection scan operation.

8. The memory system of claim 1, wherein the processing circuitry is configured to cause the memory system to:
perform the garbage collection scan operation to identify a plurality of target logical block addresses for garbage collection; and
write the first logical block address to the first change log in the volatile memory in accordance with the plurality of target logical block addresses comprising the first logical block address, wherein the value of the flag is set to a first value in response to writing the first logical block address to the first change log.

9. The memory system of claim 1, wherein the processing circuitry is configured to cause the memory system to:
perform the garbage collection scan operation to identify a plurality of target logical block addresses for garbage collection; and
refrain from writing the first logical block address to the first change log in the volatile memory in accordance with the first logical block address not being included in the plurality of target logical block addresses, wherein the value of the flag is set to a second value in response to refraining from writing the first logical block address to the first change log.

10. The memory system of claim 1, wherein a first value of the flag indicates that the first logical block address is inserted into the first change log, and wherein a second value of the flag indicates that the first logical block address is not inserted into the first change log.

11. A non-transitory computer-readable medium storing code, the code comprising instructions executable by one or more processors to:
set a value of a flag to indicate whether a first logical block address within a memory system is inserted into a first change log in a volatile memory of the memory system as part of a garbage collection scan operation;
perform, after setting the value of the flag, a merge operation associated with transferring a first plurality of entries of a logical-to-physical mapping stored at the volatile memory of the memory system to a non-volatile memory of the memory system; and
determine, after performing the merge operation and in accordance with the value of the flag, whether to transfer a second plurality of entries of a second change log from the volatile memory to the non-volatile memory, one or more entries of the second plurality of entries in the second change log comprising a mapping between a logical address of the non-volatile memory of the memory system and a physical address of the non-volatile memory.

12. The non-transitory computer-readable medium of claim 11, wherein the instructions to determine whether to transfer the second plurality of entries of the second change log from the volatile memory to the non-volatile memory are executable by the one or more processors to:
determine, in accordance with the value of the flag being a first value, to transfer the second plurality of entries of the second change log from the volatile memory to the non-volatile memory, wherein the first value of the flag indicates that the first logical block address is inserted into the first change log, and wherein the instructions are further executable by the one or more processors to:
transfer, to the non-volatile memory in accordance with the determining, at least a first entry of the second plurality of entries in the second change log; and
store, to the logical-to-physical mapping stored in the non-volatile memory, a pointer to a first physical address associated with the first entry.

13. The non-transitory computer-readable medium of claim 12, wherein the instructions are further executable by the one or more processors to:
retrieve, in response to powering on after a power loss event of the memory system, the pointer to the first physical address; and
copy, in accordance with the first physical address, the first entry from the non-volatile memory to the second change log in the volatile memory.

14. The non-transitory computer-readable medium of claim 12, wherein the instructions are further executable by the one or more processors to:
perform, after a power loss event of the memory system, a second garbage collection scan operation to identify one or more target logical block addresses for garbage collection; and
store the one or more target logical block addresses to a garbage collection address table in accordance with the second garbage collection scan operation and in accordance with transferring at least the first entry of the second change log to the non-volatile memory before the power loss event.

15. The non-transitory computer-readable medium of claim 11, wherein the instructions to determine whether to transfer the second plurality of entries of the second change log from the volatile memory to the non-volatile memory are executable by the one or more processors to:
determine, in accordance with the value of the flag being a second value, to refrain from transferring the second plurality of entries of the second change log from the volatile memory to the non-volatile memory, wherein the second value of the flag indicates that the first logical block address is not inserted into the first change log, and wherein the instructions are further executable by the one or more processors to:
invalidate, in accordance with the determining, a second physical address within the logical-to-physical mapping, wherein the second physical address is associated with the second change log.

16. The non-transitory computer-readable medium of claim 15, wherein the instructions are further executable by the one or more processors to:
retrieve, in response to powering on after a power loss event of the memory system, the second physical address from the logical-to-physical mapping in the non-volatile memory; and
refrain from rebuilding the second change log in accordance with the second physical address being invalid.

17. The non-transitory computer-readable medium of claim 15, wherein the instructions are further executable by the one or more processors to:
perform, in response to powering on after a power loss event of the memory system, a second garbage collection scan operation to identify one or more target logical block addresses for garbage collection; and
store the one or more target logical block addresses to a garbage collection address table in accordance with the second garbage collection scan operation.

18. The non-transitory computer-readable medium of claim 11, wherein the instructions are further executable by the one or more processors to:
perform the garbage collection scan operation to identify a plurality of target logical block addresses for garbage collection; and
write the first logical block address to the first change log in the volatile memory in accordance with the plurality of target logical block addresses comprising the first logical block address, wherein the value of the flag is set to a first value in response to writing the first logical block address to the first change log.

19. The non-transitory computer-readable medium of claim 11, wherein the instructions are further executable by the one or more processors to:
perform the garbage collection scan operation to identify a plurality of target logical block addresses for garbage collection; and
refrain from writing the first logical block address to the first change log in the volatile memory in accordance with the first logical block address not being included in the plurality of target logical block addresses, wherein the value of the flag is set to a second value in response to refraining from writing the first logical block address to the first change log.

20. A method by a memory system, comprising:
setting a value of a flag to indicate whether a first logical block address within the memory system is inserted into a first change log in a volatile memory of the memory system as part of a garbage collection scan operation;
performing, after setting the value of the flag, a merge operation associated with transferring a first plurality of entries of a logical-to-physical mapping stored at the volatile memory of the memory system to a non-volatile memory of the memory system; and
determining, after performing the merge operation and in accordance with the value of the flag, whether to transfer a second plurality of entries of a second change log from the volatile memory to the non-volatile memory, one or more entries of the second plurality of entries in the second change log comprising a mapping between a logical address of the non-volatile memory of the memory system and a physical address of the non-volatile memory.

21. The method of claim 20, wherein determining whether to transfer the second plurality of entries of the second change log from the volatile memory to the non-volatile memory comprises:
determining, in accordance with the value of the flag being a first value, to transfer the second plurality of entries of the second change log from the volatile memory to the non-volatile memory, wherein the first value of the flag indicates that the first logical block address is inserted into the first change log, and wherein the method further comprises:
transferring, to the non-volatile memory in accordance with the determining, at least a first entry of the second plurality of entries in the second change log; and
storing, to the logical-to-physical mapping stored in the non-volatile memory, a pointer to a first physical address associated with the first entry.

22. The method of claim 21, further comprising:
retrieving, in response to powering on after a power loss event of the memory system, the pointer to the first physical address; and
copying, in accordance with the first physical address, the first entry from the non-volatile memory to the second change log in the volatile memory.

23. The method of claim 21, further comprising:
performing, after a power loss event of the memory system, a second garbage collection scan operation to identify one or more target logical block addresses for garbage collection; and
storing the one or more target logical block addresses to a garbage collection address table in accordance with the second garbage collection scan operation and in accordance with transferring at least the first entry of the second change log to the non-volatile memory before the power loss event.
